(19) United States
(12) Patent Application Publication
(10) Pub. No.: US 2026/0320653 A1
(43) Pub. Date: Oct. 15, 2026

(54) SYSTEM AND METHOD FOR AUTOMATICALLY GENERATING OPTIMAL MESSAGE FOR ONLINE AND OFFLINE CUSTOMERS IN MULTI-CAMPAIGN ENVIRONMENT

(71) Applicant: DATARIZE INC., Seoul (KR)

(72) Inventors: Seong Moo KIM, Seoul (KR); Gyu Min LEE, Seoul (KR); Min Sung PARK, Seoul (KR)

(21) Appl. No.: 19/691,504

(22) Filed: May 28, 2026

Related U.S. Application Data
(63) Continuation of application No. PCT/KR2023/021376, filed on Dec. 22, 2023.

(30) Foreign Application Priority Data
Dec. 7, 2023 (KR) 10-2023-0176628

(51) Int. Cl. G06Q 30/0251; G06Q 30/0242

(52) U.S. Cl. CPC G06Q 30/0271; G06Q 30/0246

(57) ABSTRACT

According to an embodiment of the present disclosure, a system for automatically generating an optimal message for each online customer in a multi-campaign environment may include: an API service module configured to receive an application programming interface (API) request in real time; a profiling processing module configured to generate a target scenario and content information for each user in response to a request of the API service module and provide the target scenario and the content information to the API service module; a content generation module configured to receive the target scenario and the content information for each user from the API service module and generate scenario data to be actually exposed to each user; and a transmission processing module configured to transmit a message to each individual by each channel based on the generated scenario data for each individual.

### CROSS-REFERENCE TO RELATED APPLICATION

This application is a U.S. Bypass Continuation Application of International Application No. PCT/KR2023/021376, filed on Dec. 22, 2023, which claims priority to and the benefit of Korean Patent Application No. 10-2023-0176628, filed on Dec. 7, 2023, the disclosure of which is incorporated herein by reference in its entirety.

### BACKGROUND

### Technical Field

The present disclosure relates to a message generation system and method, and more particularly, to a technology for a system and method for automatically generating and transmitting an optimal message for each online and offline customer in a multi-campaign environment.

### Background Art

Many companies operating commerce services send emails, text messages, KakaoTalk channel messages, app push notifications, and the like for CRM (customer relationship management) purposes in order to increase the purchase conversion rate and average order value of existing members. In order to send messages, it is necessary to configure a campaign based on the five Ws and one H.

For example, in order to send a message, it is necessary to set conditions for targeted recipients who will receive the message, and it is necessary to set a date and time at which the message will be sent. In addition, in order to send a message, it is necessary to set a channel through which the message will be sent (for example, email, text message, messenger (Alimtalk and Friendtalk (KakaoTalk channels)), app push notification, or the like), and it is necessary to set text, an image, a button name, a button link, and the like included in the message (creative). In addition, in order to send a message, a target metric indicating which quantitative metric is to be achieved by sending the message should be set, and other conditions, such as how many messages are allowed to be sent to one person per day, should be set.

Message performance may basically be evaluated through four metrics, i.e., visit rate, click-through rate, purchase conversion rate, and ROAS, after a campaign is created by setting all of the five Ws and one H and the message is sent. In order to further improve performance, a method called A/B testing is mainly used, in which approximately one of the five Ws and one H is changed and the message is sent, and, for example, the four metrics of Group A and Group B may be compared. Meanwhile, although such A/B testing is an excellent method for optimizing message performance, it is cumbersome in that a marketer must manually configure the settings each time, conduct the experiment, and perform subsequent analysis. In addition, if the number of message transmissions is not large, only a single variation may be tested in one experiment, and thus a long period of time may be required until optimization is achieved.

Accordingly, there is a need for a method capable of generating and transmitting a message optimized for each customer within a short period of time with only a simple setting.

### SUMMARY

### Technical Problem

An object of the present disclosure is to provide a system and method for automatically generating an optimal message for each online and offline customer in a multi-campaign environment, capable of automatically generating an optimized message with only a few simple settings by a marketer.

### Technical Solution

According to an embodiment of the present disclosure, a system for automatically generating an optimal message for each online customer in a multi-campaign environment may include: an API service module configured to receive an application programming interface (API) request in real time; a profiling processing module configured to generate a target scenario and content information for each user in response to a request of the API service module and provide the target scenario and the content information to the API service module; a content generation module configured to receive the target scenario and the content information for each user from the API service module and generate scenario data to be actually exposed to each user; and a transmission processing module configured to transmit a message to each individual by each channel based on the generated scenario data for each individual.

The profiling processing module may include a target extraction module configured to extract scenario targets from collected behavioral information and metadata for each user according to scenario target extraction logic.

The profiling processing module may include a scenario generation module configured to identify a past scenario exposure history for each user with respect to extracted scenario targets and generate scenario data for each user based on the identified scenario exposure history.

The profiling processing module may include a priority setting module configured to identify a behavioral log for each user and set a scenario priority based on a campaign or scenario exposure log identified from the behavioral log.

The content generation module may apply a tracking code for measuring campaign performance to the scenario data.

The system may collect a behavioral log based on a transmission processing result of a personalized message transmitted according to the transmission processing module.

The behavioral log may include exposure, click, and close information of each transmitted content.

According to an embodiment of the present disclosure, a system for automatically generating an optimal message for each offline customer in a multi-campaign environment may include: a batch processing module configured to perform a batch job set according to time triggering; a profiling processing module configured to generate a target scenario and content information for each user in response to a request of the batch processing module; a priority setting module configured to sort a plurality of scenario data based on priority information derived from past campaign performance of a customer company; a content generation module configured to receive the target scenario and the content information for each user and generate scenario data to be actually exposed to each user; and a transmission processing module configured to transmit a message to each individual by each channel based on the generated scenario data for each individual.

The profiling processing module may include a target extraction module configured to extract scenario targets from collected behavioral information and metadata for each user according to scenario target extraction logic.

The profiling processing module may include a scenario generation module configured to identify a past scenario exposure history for each user with respect to extracted scenario targets and generate scenario data for each user based on the identified scenario exposure history.

The profiling processing module may include a channel information identification module configured to identify whether each user is online and which channels are reachable to each user based on channel status information for each user.

The profiling processing module may include a user response identification module configured to identify a behavioral log for each user and identify a response of each user for each channel based on an action message log identified from the behavioral log.

The content generation module may apply a tracking code for measuring campaign performance to the scenario data.

The system may collect a behavioral log based on a transmission processing result of a personalized message transmitted according to the transmission processing module.

The behavioral log may include exposure, click, and close information of each transmitted content.

### Advantageous Effects

According to the present disclosure, there is an advantage in that an optimized message can be automatically generated and transmitted with only a few simple settings by a marketer, without the need to experiment with, measure, determine, and adjust all of the elements corresponding to the above-described five Ws and one H.

For example, there is an advantage in that, when a marketer inputs only simple settings, an item of interest may be estimated for each member, and creative content (for example, an image, text, or the like) may be automatically generated and transmitted.

### BRIEF DESCRIPTION OF THE DRAWINGS

FIG. 1 is a block diagram illustrating a detailed configuration of a system for automatically generating an optimal message for each customer in a multi-campaign environment according to an embodiment of the present disclosure.

FIG. 2 is a block diagram illustrating a detailed configuration of a scenario processing module according to an embodiment of the present disclosure.

FIG. 3 is a block diagram illustrating a detailed configuration of a scenario selection module according to an embodiment of the present disclosure.

FIG. 4 is a flowchart illustrating a method for automatically generating an optimal message for each customer in a multi-campaign environment according to an embodiment of the present disclosure.

FIG. 5 is a block diagram illustrating a detailed configuration of a system for automatically generating an optimal message for each online customer in a multi-campaign environment according to an embodiment of the present disclosure.

FIG. 6 is a block diagram illustrating a detailed configuration of a profiling processing module according to an embodiment of the present disclosure.

FIG. 7 is a block diagram illustrating a detailed configuration of a system for automatically generating an optimal message for each offline customer in a multi-campaign environment according to an embodiment of the present disclosure.

FIG. 8 is a block diagram illustrating a detailed configuration of a profiling processing module according to an embodiment of the present disclosure.

FIG. 9 is a diagram illustrating a concept of profiling generation according to an embodiment of the present disclosure.

FIG. 10 is a block diagram illustrating a system for automatically generating an optimal message for each customer in a multi-campaign environment according to an embodiment of the present disclosure.

### DETAILED DESCRIPTION

Embodiments of the present disclosure will now be described in detail with reference to the accompanying drawings. However, the present disclosure is not limited or restricted to the embodiments.

Terms used herein are for describing the embodiments and are not intended to limit the present disclosure. As used herein, singular forms also include plural forms unless the context clearly indicates otherwise. As used herein, the terms “comprises” and/or “comprising” do not preclude the presence or addition of one or more other elements, steps, operations, and/or devices in addition to the stated elements, steps, operations, and/or devices.

As used herein, terms such as “embodiment,” “example,” “aspect,” and “illustration” are not to be construed as indicating that any described aspect or design is superior to or advantageous over other aspects or designs.

Further, the term “or” is intended to mean an inclusive or rather than an exclusive or. That is, unless otherwise stated or unless clear from the context, the expression “x uses a or b” means any one of the natural inclusive permutations.

Further, as used herein and in the claims, a singular expression (“a” or “an”) should generally be construed to mean “one or more” unless otherwise stated or unless it is clear from the context that the expression is directed to a singular form.

Further, as used herein and in the claims, terms such as “first” and “second” may be used to describe various elements, but the elements should not be limited by such terms. Such terms are used only for the purpose of distinguishing one element from another element.

Unless otherwise defined, all terms used herein, including technical and scientific terms, may be used with meanings commonly understood by a person having ordinary skill in the art to which the present disclosure pertains. In addition, terms defined in generally used dictionaries are not to be interpreted ideally or excessively unless they are clearly and specifically defined otherwise.

Meanwhile, in describing the present disclosure, when it is determined that a detailed description of a related known function or configuration may unnecessarily obscure the gist of the present disclosure, the detailed description thereof will be omitted. In addition, the terminology used herein is terminology used to properly describe embodiments of the present disclosure, and may vary depending on the intent of a user or operator or on custom in the field to which the present disclosure pertains. Accordingly, the definitions of such terms should be made based on the contents throughout this specification.

In various embodiments described below, a campaign may be a concept including an advertisement, but is not limited to specific advertisement data. According to an embodiment, campaign information may be referred to as scenario data, and the scenario data may include at least one of text, an image, a video, and an animation.

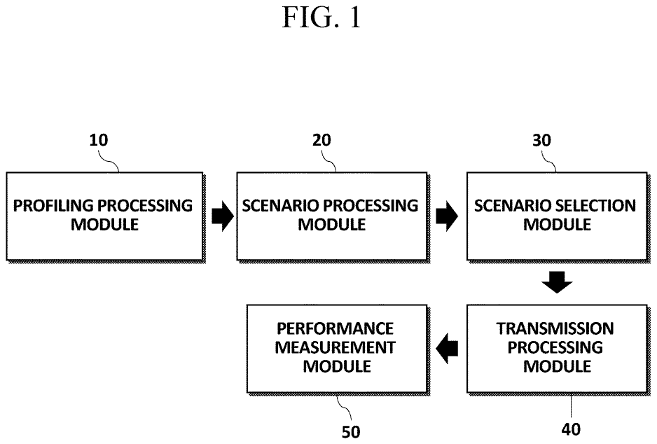

FIG. 1 is a block diagram illustrating a detailed configuration of a system for automatically generating an optimal message for each customer in a multi-campaign environment according to an embodiment of the present disclosure.

Referring to FIG. 1, the system for automatically generating an optimal message for each customer in a multi-campaign environment according to an embodiment of the present disclosure may include a profiling processing module 10, a scenario processing module 20, a scenario selection module 30, a transmission processing module 40, and a performance measurement module 50.

The profiling processing module 10 may generate profiling based on behavioral data on a browser and metadata of a customer company. For example, the behavioral data on the browser may include at least one of a page uniform resource locator (URL), an item exposure count, cart information, purchase information, and scroll information. The metadata of the customer company may include at least one of purchase history, member information, and promotion information. The profiling processing module 10 may calculate profiling based on information of the customer company itself (for example, metadata of the customer company) and behavioral information of each customer (for example, behavioral data on the browser). According to an embodiment, the profiling may include at least one of an interest level in a specific item, an interest level in a specific category, a purchase probability, and a revisit probability. The profiling may be calculated according to a known calculation method.

The profiling processing module 10 may generate profiling result data according to the profiling generation process. In this case, the profiling result data may include goal-oriented profiling data. For example, the goal-oriented profiling data may be generated by automatic tuning based on profiling parameters derived from a marketing action and performance thereof. The profiling result may be generated for each date and/or for each time. The profiling result may include individual profiling data, and may further include a target and information regarding a subsequent marketing action.

According to an embodiment, the scenario processing module 20 may generate a plurality of scenario data based on the profiling result data generated by the profiling processing module 10.

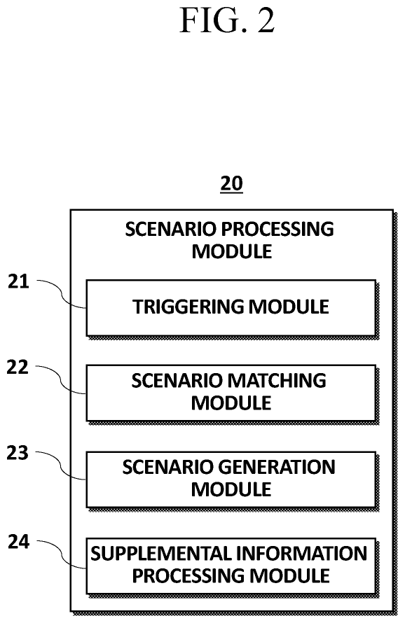

Hereinafter, the scenario processing module 20 will be described in detail with reference to FIG. 2.

FIG. 2 is a block diagram illustrating a detailed configuration of a scenario processing module according to an embodiment of the present disclosure.

Referring to FIG. 2, the scenario processing module 20 according to an embodiment may include a triggering module 21, a scenario matching module 22, a scenario generation module 23, and a supplemental information processing module 24.

According to an embodiment, the triggering module 21 may trigger simultaneous processing of batch data generation for scenario data and real-time requests for scenario data. To this end, the triggering module 21 may have a dualized architecture configured to simultaneously process the batch data generation operation and the real-time requests.

The scenario matching module 22 may select a target scenario based on a campaign execution status of a customer company, individual profiling, and performance data. For example, the campaign execution status of the customer company may include an activated marketing channel or a set time. The individual profiling and performance data may include data reflecting, for each campaign and for each period, a prior exposure status or an individual's intent (for example, turning off exposure).

The scenario generation module 23 may generate a plurality of scenario data for each individual. For example, because scenario data assigned to each individual may be selectively dropped later, the scenario generation module 23 may generate the plurality of scenario data.

The supplemental information processing module 24 may additionally generate supplemental information to be mandatorily included in a campaign. The supplemental information generated by the supplemental information processing module 24 may be attached to each of the plurality of scenario data generated by the scenario generation module 23.

Referring back to FIG. 1, according to an embodiment, the scenario selection module 30 may select final data for each individual from among the plurality of scenario data generated by the scenario processing module 20.

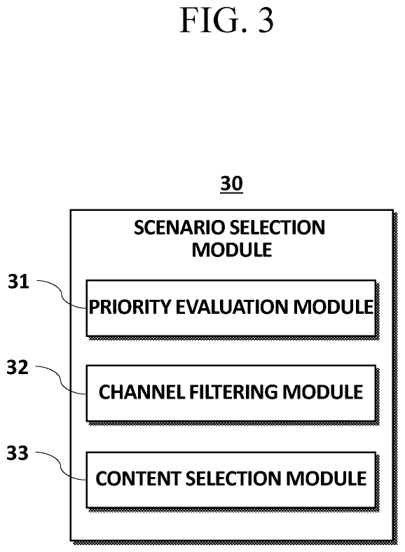

Hereinafter, the scenario selection module 30 will be described in detail with reference to FIG. 3.

FIG. 3 is a block diagram illustrating a detailed configuration of a scenario selection module according to an embodiment of the present disclosure.

Referring to FIG. 3, the scenario selection module 30 may include a priority evaluation module 31, a channel filtering module 32, and a content selection module 33.

According to an embodiment, the priority evaluation module 31 may sort a plurality of scenario data based on priority information derived from a customer company's past campaign performance. For example, the priority evaluation module 31 may select and configure a plurality of metrics, such as open rate, click-through rate, and ROAS (Return on Ad Spend), according to a campaign objective. The priority evaluation module 31 may further include response logic for a new campaign (cold start).

According to an embodiment, the channel filtering module 32 may remove unnecessary data by filtering, from among the plurality of scenario data, unnecessary data (for example, scenario data) according to settings/policies such as a channel status and cost control for each customer company. In this manner, by removing unnecessary data from among the plurality of scenario data, billing may be controlled, and overbilling and erroneous transmission may be blocked in advance.

According to an embodiment, the content selection module 33 may perform an operation of selecting content (for example, scenario data) to be actually exposed to a customer and generating final scenario data. The content selection module 33 may generate scenario data for each individual based on previously received campaign data for each customer. In this case, the content selection module 33 may apply a tracking means for measuring campaign performance.

Referring back to FIG. 1, according to an embodiment, the transmission processing module 40 may process transmission of final scenario data selected by the scenario selection module 30 for each individual and for each channel. For example, the transmission processing module 40 may process transmission of the final scenario data selected by the scenario selection module 30 by at least one means of banner, email, SMS, MMS, notification talk, channel talk, talk provided by a portal site, and app push. In this case, the transmission processing module 40 may transmit a personalized message (for example, scenario data) in real time or at a preset time. The transmission processing module 40 may determine channel status of a site by collecting indicators related to transmission itself, such as transmission success or exposure success.

According to an embodiment, the performance measurement module 50 may measure performance of a campaign. For example, the performance measurement module 50 may collect different feedback data according to characteristics of each channel. In this case, the performance measurement module 50 may collect direct response data of a recipient based on a user's open or click behavior. In addition, the performance measurement module 50 may link in-site behavioral data after the response of the recipient. In addition, the performance measurement module 50 may configure a feedback loop such that the performance measurement result is reflected back in profiling of the customer. Accordingly, the profiling processing module 10 described above may regenerate profiling of the customer based on the performance measurement result received as feedback from the performance measurement module 50.

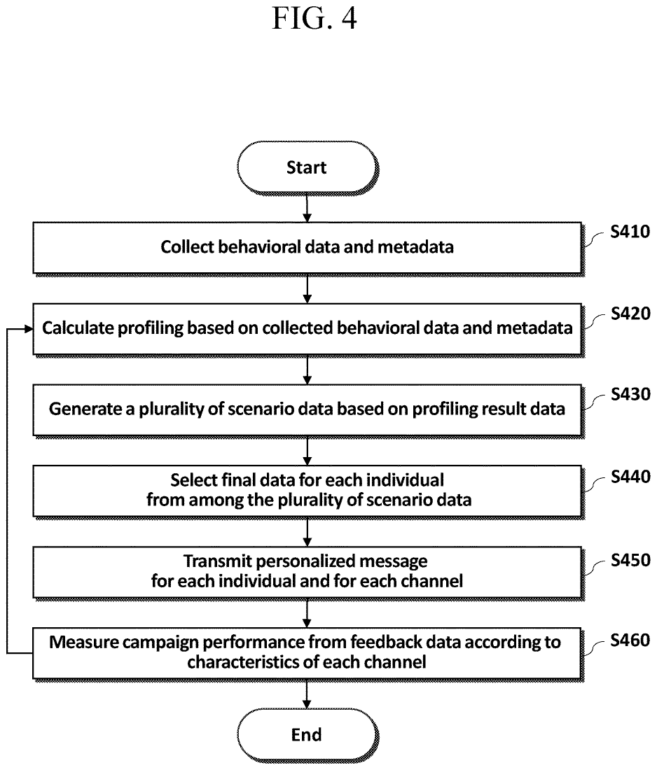

FIG. 4 is a flowchart illustrating a method for automatically generating an optimal message for each customer in a multi-campaign environment according to an embodiment of the present disclosure.

Referring to FIG. 4, according to an embodiment, the system for automatically generating an optimal message for each customer in a multi-campaign environment may first collect behavioral data on a browser and metadata of a customer company (S410). The system for automatically generating an optimal message for each customer in a multi-campaign environment may then perform a step of generating profiling based on the collected behavioral data and metadata (S420).

Next, the system for automatically generating an optimal message for each customer in a multi-campaign environment may generate a plurality of scenario data based on result data of the generated profiling (S430).

Next, the system for automatically generating an optimal message for each customer in a multi-campaign environment may select final data for each individual from among the plurality of scenario data (S440).

Next, the system for automatically generating an optimal message for each customer in a multi-campaign environment may transmit the selected final data for each individual and for each channel (S450).

Finally, the system for automatically generating an optimal message for each customer in a multi-campaign environment may measure campaign performance from feedback data according to characteristics of each channel (S460). In addition, the campaign performance measurement result may form a feedback loop such that the campaign performance measurement result is reflected back in profiling of the customer. Accordingly, profiling may be regenerated in step S420 based on the performance measurement result in step S460 received as feedback.

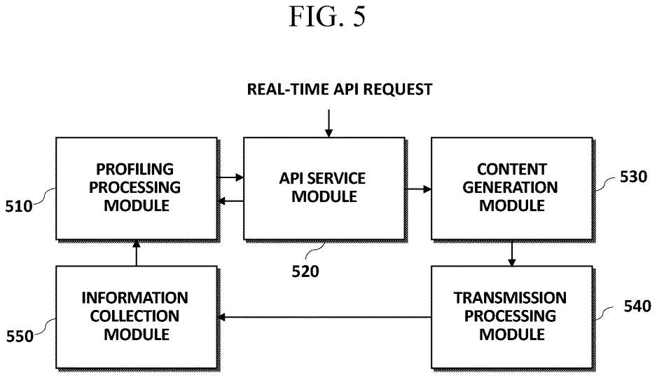

FIG. 5 is a block diagram illustrating a detailed configuration of a system for automatically generating an optimal message for each online customer in a multi-campaign environment according to an embodiment of the present disclosure.

Referring to FIG. 5, the system for automatically generating an optimal message for each online customer in a multi-campaign environment according to an embodiment of the present disclosure may include a profiling processing module 510, an application programming interface (API) service module 520, a content generation module 530, a transmission processing module 540, and an information collection module 550.

The API service module 520 may receive an API request in real time. The API service module 520 may request the profiling processing module 510 to perform profiling processing in response to a real-time API request.

The profiling processing module 510 may generate target scenario and content information for each user in response to the request of the API service module 520. The profiling processing module 510 may receive behavioral information and metadata for each user to extract scenario targets and identify past scenario exposure history information. The profiling processing module 510 may generate scenario data for each user based on the past scenario exposure history of the scenario targets. In addition, the profiling processing module 510 may receive a behavioral log and identify a campaign or scenario exposure log (for example, an action banner log) through the behavioral log. The profiling processing module 510 may set a scenario priority based on the identified campaign or scenario exposure log (for example, the action banner log).

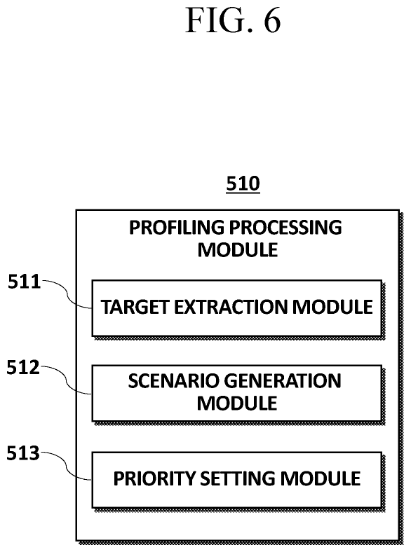

Hereinafter, the profiling processing module 510 will be described in detail with reference to FIG. 6.

FIG. 6 is a block diagram illustrating a detailed configuration of a profiling processing module according to an embodiment of the present disclosure.

Referring to FIG. 6, the profiling processing module 510 may include a target extraction module 511, a scenario generation module 512, and a priority setting module 513.

The target extraction module 511 may extract scenario targets from collected behavioral information and metadata for each user according to scenario target extraction logic.

The scenario generation module 512 may identify a past scenario exposure history for each user with respect to the extracted scenario targets, and may generate scenario data for each user based on the identified scenario exposure history.

The priority setting module 513 may identify a behavioral log for each user, and may identify a campaign or scenario exposure log (for example, an action banner log) from the behavioral log. The priority setting module 513 may set a scenario priority based on the identified campaign or scenario exposure log (for example, the action banner log).

Referring back to FIG. 5, the API service module 520 may receive, from the profiling processing module 510, target scenario and content information for each user as a result of a profiling processing request for the profiling processing module 510. The API service module 520 may transmit the target scenario and content information for each user received from the profiling processing module 510 to the content generation module 530.

According to an embodiment, the content generation module 530 may perform an operation of selecting content (for example, scenario data) to be actually exposed to a customer and generating final scenario data. The content generation module 530 may generate scenario data for each individual based on previously received campaign data for each customer and template information. In this case, the content generation module 530 may apply a tracking means (or a tracking code) for measuring campaign performance.

According to an embodiment, the transmission processing module 540 may process transmission of final scenario data for each individual and for each channel based on the content selected by the content generation module 530 and a transmission request data list. For example, the transmission processing module 540 may process transmission of the final scenario data generated by the content generation module 530 by a banner or a JavaScript function (js function). In this case, the transmission processing module 540 may transmit a personalized message (for example, scenario data) in real time or at a preset time. The transmission processing module 540 may determine channel status of a site by collecting indicators related to transmission itself, such as transmission success or exposure success.

According to an embodiment, the information collection module 550 may collect, as a behavioral log, a transmission processing result of the personalized message transmitted according to the transmission processing module 540, and exposure, click, close information, and the like of each transmitted content. The information collection module 550 may transmit the collected behavioral log to the profiling processing module 510. That is, the information collection module 550 may configure a feedback loop such that the collected behavioral log is reflected back in profiling of the customer. Accordingly, the profiling processing module 510 described above may regenerate profiling of the customer based on the performance measurement result received as feedback from the information collection module 550.

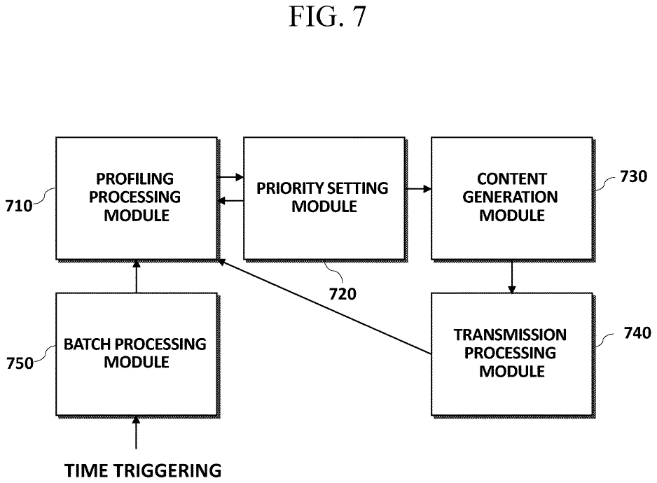

FIG. 7 is a block diagram illustrating a detailed configuration of a system for automatically generating an optimal message for each offline customer in a multi-campaign environment according to an embodiment of the present disclosure.

Referring to FIG. 7, the system for automatically generating an optimal message for each offline customer in a multi-campaign environment according to an embodiment of the present disclosure may include a profiling processing module 710, a priority setting module 720, a content generation module 730, a transmission processing module 740, and a batch processing module 750.

The batch processing module 750 may perform a batch job set according to time triggering. For example, the batch processing module 750 may request the profiling processing module 710 to perform profiling processing according to the set batch job.

The profiling processing module 710 may generate target scenario and content information for each user in response to a request of the batch processing module 750.

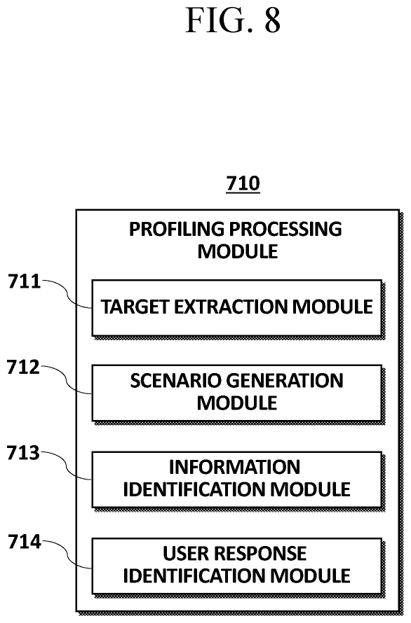

Hereinafter, the profiling processing module 710 will be described in detail with reference to FIG. 8.

FIG. 8 is a block diagram illustrating a detailed configuration of a profiling processing module according to an embodiment of the present disclosure.

Referring to FIG. 8, the profiling processing module 710 may include a target extraction module 711, a scenario generation module 712, a channel information identification module 713, and a user response identification module 714.

The target extraction module 711 may extract scenario targets from collected behavioral information and metadata for each user according to scenario target extraction logic.

The scenario generation module 712 may identify a past scenario exposure history for each user with respect to the extracted scenario targets, and may generate scenario data for each user based on the identified scenario exposure history.

The channel information identification module 713 may identify, based on channel status information for each user, whether each user is online and which channels are reachable to each user.

The user response identification module 714 may identify a behavioral log for each user and may identify an action message log from the behavioral log. The user response identification module 714 may identify a response of each user for each channel based on the identified action message log.

Referring back to FIG. 7, the profiling processing module 710 may generate profiling result data according to the profiling generation process. In this case, the profiling result data may include goal-oriented profiling data. For example, the goal-oriented profiling data may be generated by automatically tuning based on profiling parameters based on a marketing action and performance thereof. The profiling result may be generated for each date and/or for each time. The profiling result may include individual profiling data, and may further include a target and information of a subsequent marketing action.

According to an embodiment, the priority setting module 720 may sort a plurality of scenario data based on priority information derived from past campaign performance of the customer company. For example, the priority setting module 720 may select and configure a plurality of metrics, such as open rate, click-through rate, and ROAS (Return on Ad Spend), according to a campaign objective. The priority setting module 720 may further include response logic for a new campaign (cold start).

According to an embodiment, the content generation module 730 may perform an operation of selecting content (for example, scenario data) to be actually exposed to a customer and generating final scenario data. The content generation module 730 may generate scenario data for each individual based on previously received campaign data for each customer and template information. In this case, the content generation module 730 may apply a tracking means for measuring campaign performance.

According to an embodiment, the transmission processing module 740 may process transmission of final scenario data generated by the content generation module 730 for each individual and for each channel. For example, the transmission processing module 740 may process transmission of the final scenario data generated by the content generation module 730 by at least one means of email, SMS, MMS, notification talk, channel talk, talk provided by a portal site, and app push. In this case, the transmission processing module 740 may transmit a personalized message (for example, scenario data) in real time or at a preset time. The transmission processing module 740 may generate, as a behavioral log, transmission success, delivery, open, click, and the like, and may feed the behavioral log back to the profiling processing module 710. For example, the profiling processing module 710 described above may regenerate profiling of the customer based on the fed-back behavioral log.

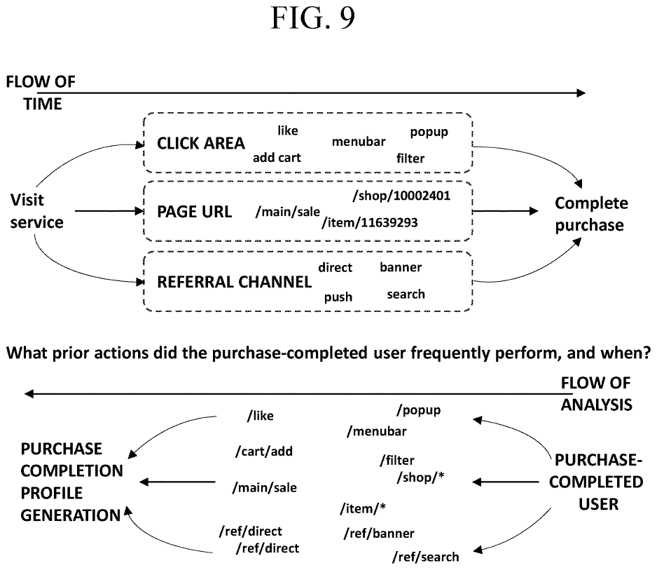

FIG. 9 is a diagram illustrating a concept of profiling generation according to an embodiment of the present disclosure.

Referring to FIG. 9, a user may perform various actions over time from visiting a service to completing a purchase. In this case, collected information may include information regarding a click area, a page uniform resource locator (URL), and a referral channel.

According to an embodiment, in order to analyze a profile of a user, the analysis may be performed in a direction opposite to the flow of time. For example, based on information collected from a user who has completed a purchase, a purchase-completion profile may be generated, as shown in FIG. 9. The method shown in FIG. 9 may be referred to as an ad hoc profiling method, although the present disclosure is not limited thereto.

In order to generate the profiling, actions may first be tokenized. That is, activities generated by a user (that is, a customer) may be defined and converted into unique token values. For example, all detectable actions, such as a visit to a first page found on a browser, entry into a cart page, a click, and a visit time, may be tokenized and stored.

Next, a token corresponding to a goal may be selected as a target. In this case, any action may be set as a goal. For example, a token corresponding to a purchase completion goal, a product detail page visit goal, a purchase amount of 100,000 won or more goal, or the like may be selected as a target.

Next, an initial parameter based on a relative value may be set. That is, a parameter may be set for a goal action found in a behavioral sequence for each customer. The goal action may be set as various features, such as whether the goal action occurred in a customer session (yes or no) or a frequency thereof (0 to x). In addition, depending on whether the goal action occurred, customers may be divided into as many clusters as necessary, and relative values among token features, such as whether a token occurred and a frequency for each cluster, may be calculated.

Next, the parameter may be optimized through test verification. That is, parameter optimization may be performed by applying the initial parameter to a test data set and comparing the result. The test verification may be performed using a test data set prepared by dividing data at a predetermined ratio when the initial parameter is set, or may be performed by optimizing the parameter to a latest value using a time-divided data set.

Finally, profiling may be performed by applying new data. By applying an optimal parameter obtained at a corresponding point in time in the above steps to new customer data, a probability of occurrence of a goal token may be calculated. That is, based on an action that has already occurred within one session, a probability of inducing an arbitrary goal action may be calculated. For example, as a result of performing the profiling, a subject having a high purchase probability, a high-churn group, a person interested in a specific category, and a long-term non-visitor may be identified.

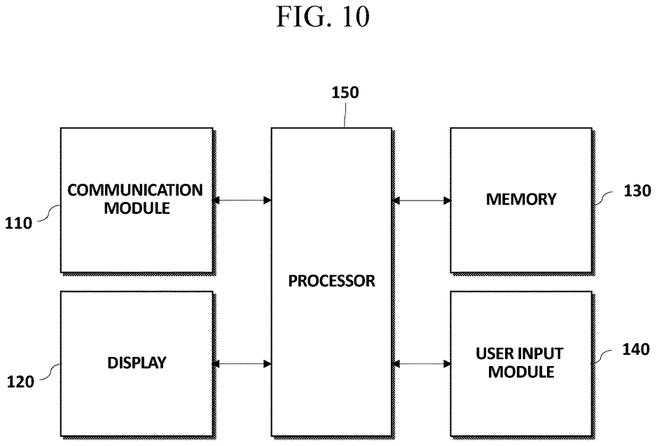

FIG. 10 is a block diagram illustrating a system for automatically generating an optimal message for each customer in a multi-campaign environment according to an embodiment of the present disclosure.

Referring to FIG. 10, the system for automatically generating an optimal message for each customer in a multi-campaign environment according to an embodiment may include a communication module 110, a display 120, a memory 130, a user input module 140, and a processor 150.

According to an embodiment, the communication module 110 may receive, from an external server, behavioral data on a browser and customer company metadata input to the profiling processing modules 10, 510, and 710. The behavioral data on the browser and the customer company metadata collected through the communication module 110 may be provided to the processor 150. The memory 130 may store the behavioral data on the browser and the customer company metadata collected through the communication module 110.

According to an embodiment, the processor 150 may process functions performed by the profiling processing modules 10, 510, and 710 based on the data collected through the communication module 110. For example, the processor 150 may perform functions of the respective modules shown in FIGS. 1, 5, and 7.

According to an embodiment, the processor 150 may transmit, through the communication module 110, selected final data (for example, scenario data) for each individual and for each channel.

According to an embodiment, the user input module 140 may receive a scenario triggering request (for example, a batch data generation request and/or a real-time request) from a user. The display 120 may display, on a screen, data input during a scenario data generation process or generated data. In addition, the display 120 may display, on the screen, a performance measurement result measured by the performance measurement module 50 after transmission of a personalized scenario message.

The apparatus described above may be implemented using hardware components, software components, and/or a combination of hardware components and software components. For example, the apparatuses and components described in the embodiments may be implemented using one or more general-purpose computers or special-purpose computers, such as, for example, a processor, a controller, an ALU (arithmetic logic unit), a digital signal processor, a microcomputer, an FPA (field programmable array), a PLU (programmable logic unit), a microprocessor, or any other device capable of executing and responding to an instruction. A processing device may execute an operating system (OS) and one or more software applications executed on the operating system. In addition, the processing device may access, store, manipulate, process, and generate data in response to execution of the software. For convenience of understanding, although a single processing device may be described as being used, a person having ordinary skill in the art will appreciate that the processing device may include a plurality of processing elements and/or a plurality of types of processing elements. For example, the processing device may include a plurality of processors or a single processor and a single controller. In addition, other processing configurations, such as a parallel processor, are also possible.

Software may include a computer program, code, an instruction, or one or more combinations thereof, and may configure the processing device to operate as desired or may instruct the processing device independently or collectively. The software and/or data may be permanently or temporarily embodied in any type of machine, component, physical device, virtual equipment, computer storage medium or device, or transmitted signal wave, in order to be interpreted by the processing device or to provide instructions or data to the processing device. The software may be distributed over network-connected computer systems so as to be stored or executed in a distributed manner. The software and data may be stored in one or more computer-readable recording media.

A method according to an embodiment may be implemented in the form of program instructions executable by various computer means and recorded in a computer-readable medium. The computer-readable medium may include the program instructions, a data file, a data structure, or a combination thereof, alone or in combination. The program instructions recorded in the medium may be specially designed and configured for the embodiments, or may be known and available to those skilled in the art of computer software. Examples of the computer-readable recording medium include magnetic media such as hard disks, floppy disks, and magnetic tapes; optical recording media such as CD-ROMs and DVDs; magneto-optical media such as floptical disks; and hardware devices specially configured to store and execute program instructions, such as ROM, RAM, and flash memory. Examples of the program instructions include not only machine language code, such as that generated by a compiler, but also high-level language code executable by a computer using an interpreter or the like. The hardware devices described above may be configured to operate as one or more software modules in order to perform operations of the embodiments, and vice versa.

Although the embodiments have been described above with reference to limited embodiments and drawings, various modifications and changes may be made thereto by those skilled in the art based on the foregoing description. For example, appropriate results may be achieved even if the described techniques are performed in a sequence different from the described method, and/or components of the described system, structure, device, circuit, and the like are combined or arranged in a form different from the described method, or are replaced or substituted with other components or equivalents.

Therefore, other implementations, other embodiments, and equivalents to the appended claims are also within the scope of the following claims.

What is claimed is:

1. A system, comprising a processor, for automatically generating an optimal message for each online customer in a multi-campaign environment, the system comprising:
an application programming interface (API) service module configured to receive an API request in real time;
a profiling processing module configured to generate target scenario and content information for each user in response to a request of the API service module and provide the target scenario and the content information to the API service module;
a content generation module configured to receive the target scenario and the content information for each user from the API service module and generate scenario data to be actually exposed to each user; and
a transmission processing module configured to transmit a message to each individual by each channel based on the generated scenario data for each individual.

2. The system of claim 1, wherein the profiling processing module comprises a target extraction module configured to extract scenario targets from collected behavioral information and metadata for each user according to scenario target extraction logic.

3. The system of claim 1, wherein the profiling processing module comprises a scenario generation module configured to identify a past scenario exposure history for each user with respect to extracted scenario targets and generate scenario data for each user based on the identified scenario exposure history.

4. The system of claim 1, wherein the profiling processing module comprises a priority setting module configured to identify a behavioral log for each user and set a scenario priority based on a campaign or scenario exposure log identified from the behavioral log.

5. The system of claim 1, wherein the content generation module is configured to apply a tracking code for measuring campaign performance to the scenario data.

6. The system of claim 1, further comprising an information collection module configured to collect a behavioral log based on a transmission processing result of a personalized message transmitted according to the transmission processing module.

7. The system of claim 6, wherein the behavioral log includes exposure, click, and close information of each transmitted content.

8. A system, comprising a processor, for automatically generating an optimal message for each offline customer in a multi-campaign environment, the system comprising:
a batch processing module configured to perform a batch job set according to time triggering;
a profiling processing module configured to generate target scenario and content information for each user in response to a request of the batch processing module;
a priority setting module configured to sort a plurality of scenario data based on priority information derived from past campaign performance of a customer company;
a content generation module configured to receive the target scenario and the content information for each user and generate scenario data to be actually exposed to each user; and
a transmission processing module configured to transmit a message to each individual by each channel based on the generated scenario data for each individual.

9. The system of claim 8, wherein the profiling processing module comprises a target extraction module configured to extract scenario targets from collected behavioral information and metadata for each user according to scenario target extraction logic.

10. The system of claim 8, wherein the profiling processing module comprises a scenario generation module configured to identify a past scenario exposure history for each user with respect to extracted scenario targets and generate scenario data for each user based on the identified scenario exposure history.

11. The system of claim 8, wherein the profiling processing module comprises a channel information identification module configured to identify, based on channel status information for each user, whether each user is online and which channels are reachable to each user.

12. The system of claim 8, wherein the profiling processing module comprises a user response identification module configured to identify a behavioral log for each user and identify a response of each user for each channel based on an action message log identified from the behavioral log.

13. The system of claim 8, wherein the content generation module is configured to apply a tracking code for measuring campaign performance to the scenario data.

14. The system of claim 8, further comprising an information collection module configured to collect a behavioral log based on a transmission processing result of a personalized message transmitted according to the transmission processing module.

15. The system of claim 14, wherein the behavioral log includes exposure, click, and close information of each transmitted content.
